(19) United States
(12) Patent Application Publication
(10) Pub. No.: US 2005/0138895 A1
(43) Pub. Date: Jun. 30, 2005

(54) Beverage bottling plant for filling bottles with a liquid beverage filling material and a method of operating a beverage bottling plant

(76) Inventor: Martin Schach, Bochum (DE)

Correspondence Address: NILS H. LJUNGMAN & ASSOCIATES, P. O. BOX 130, GREENSBURG, PA, 15601-0130, US

(21) Appl. No.: 11/004,663

(22) Filed: Dec. 3, 2004

(30) Foreign Application Priority Data
Dec. 5, 2003 (DE) 103 57 329

(51) Int. Cl. B65B 61/00; B65B 7/28; B67B 3/00

(52) U.S. Cl. 53/415; 53/426; 53/485; 53/167; 53/136.1; 53/281

(57) ABSTRACT

A beverage bottling plant for filling bottles with a liquid beverage filling material and a method of operating a beverage bottling plant. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

The present application relates to a beverage bottling plant for filling bottles with a liquid beverage filling material and a method of operating a beverage bottling plant.

2. Background Information

A beverage bottling plant for filling bottles with a liquid beverage filling material can possibly comprise a beverage filling machine with a plurality of beverage filling positions, each beverage filling position having a beverage filling device for filling bottles with liquid beverage filling material. The filling devices may have an apparatus designed to introduce a predetermined volume of liquid beverage filling material into the interior of bottles to a substantially predetermined level of liquid beverage filling material. The apparatus designed to introduce a predetermined flow of liquid beverage filling material further comprises an apparatus that is designed to terminate the filling of the beverage bottles upon the liquid beverage filling material reaching the predetermined level in bottles. There may also be provided a conveyer arrangement that is designed to move bottles, for example, from an inspecting machine to the filling machine. Upon filling, a closing station closes the filled bottles. There may further be provided a conveyer arrangement configured to transfer filled bottles from the filling machine to the closing station. Bottles may be labeled in a labeling station, the labeling station having a conveyer arrangement to receive bottles and to output bottles. The closing station and the labeling station may be connected by a corresponding conveyer arrangement.

The present application also relates to labeling machines that are used to label containers such as bottles, cans or similar objects, whereby the scope of the present application includes both labeling machines that used cold-setting adhesive as well as labeling machines for the processing of self-adhesive labels, and to mixed and/or combination types of such labeling machines.

The scope of the present application also includes continuous-motion rotary labeling machines which have a turntable that revolves around its vertical axis with receptacles for the containers, as well as linear machines in which the containers are moved essentially in a straight line past at least one labeling station, whereby the containers can also execute a rotational movement around their vertical axis.

The labeling of containers is of particular importance in the beverage and packing industry because advantageous and attractive labeling of the containers makes an essential contribution to the market success of a product. In this context, it is particularly desirable for the labels to be applied to the containers smoothly and without folds and creases.

In labeling machines of the prior art, this problem is solved by first having the labels transferred to the containers by a dispensing and/or transfer device. When the labels in question are self-adhesive, for example, this device can be the edge of the dispenser, and on machines that use cold-setting adhesive labeling it can be a gripper cylinder with applicator sponges.

In the context of this transfer process, the label is generally fastened to the container only over a portion of its surface, which means that the remaining surfaces of the label must then be pressed against the container, for which purpose brushes are conventionally used which are located along the further path of the container so that they cause the label to be pressed against the container in the desired manner, possibly in combination with an additional rotation of the container.

In the prior art, these brushes are located in the form of individual brushes, but also in the form of a brush channel, on one side or also on both sides of the container path.

Up to now, the task described above has been performed exclusively by brushes in which the bristles of the brush are oriented essentially perpendicular to the direction of movement of the containers.

The prior art also uses brushes with a bristle length of approximately 50 millimeters, whereby the brushes are located and oriented so that as the cans pass the brushes, they are immersed approximately 20 to 30 millimeters deep in the bristles.

As a result of the orientation of the bristles perpendicular to the direction of movement and the great depth of immersion of the containers, the bristles are subjected to a great deal of bending stress, as a result of which said brushes are subjected to a high degree of wear. On high-capacity labeling machines in particular, this wear results in extremely short lives for these brushes, which requires the frequent replacement of the brushes and time-consuming adjustment work.

In practice, cases have been reported in which the useful life of such brushes is only one working day, as a result of which long down times and high costs result, which is naturally undesirable in practice.

To the best of the applicant's knowledge, no proposals have been offered to solve these problems.

### OBJECT OR OBJECTS

The object is to eliminate the disadvantages described above. For this purpose, the present application teaches a labeling machine on which brushes are used, the bristles of which are not oriented perpendicular to the direction of movement but form an angle which is less than 90 degrees with respect to the direction of movement.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The embodiments are explained in greater detail below with reference to one exemplary embodiment which is illustrated in the accompanying drawings, in which:

FIG. 1A is a schematic illustration of a container filling plant in accordance with one possible embodiment;

FIG. 1 is a simplified illustration of a labeling machine of the prior art, with brushes and brush channels of the prior art;

FIG. 2 is a simplified illustration of a labeling machine as claimed by the present application, in a continuous motion rotary model, for the processing of self-adhesive labels;

FIG. 2A shows an expanded view of a brush section of a labeling machine according to at least one possible embodiment;

FIG. 3 shows a brush base body with bundles of bristles arranged in the shape of an arrow;

FIG. 4 shows a top view of a rotatable brush cylinder with a vertical axis of rotation for use in a labeling machine according to at least one possible embodiment;

FIG. 4a shows an alternative embodiment of the arrangement shown in FIG. 4 with more than one brush cylinder;

FIG. 5 shows a top view of a rotatable brush cylinder with a horizontal axis of rotation for use in a labeling machine according to at least one possible embodiment; and

FIG. 5a shows a side view of the arrangement shown in FIG. 5.

### DESCRIPTION OF EMBODIMENT OR EMBODIMENTS

Developments, advantages and potential applications of the embodiments are described below on the basis of exemplary embodiments and the accompanying drawings. All of the features described and/or illustrated, individually and/or in any desired combination, are the object of the present application, regardless of how they are combined in the claims or the references between claims. The text of the claims is also an integral part of this description and is hereby incorporated by reference.

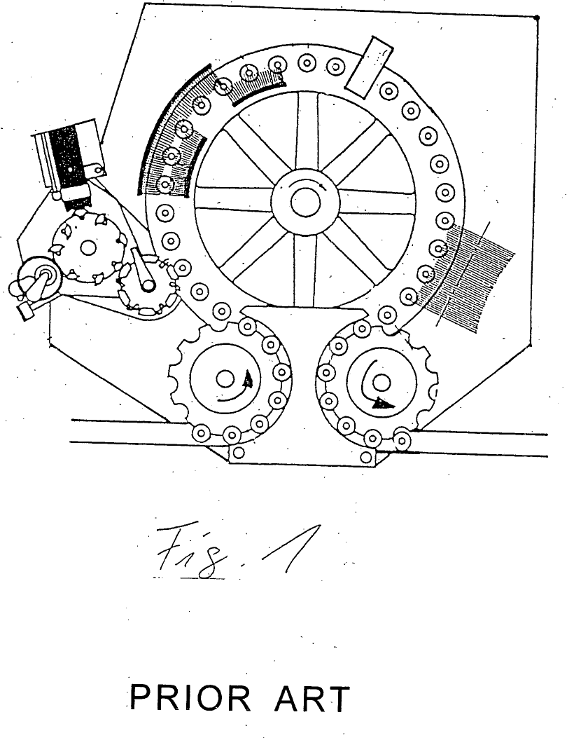

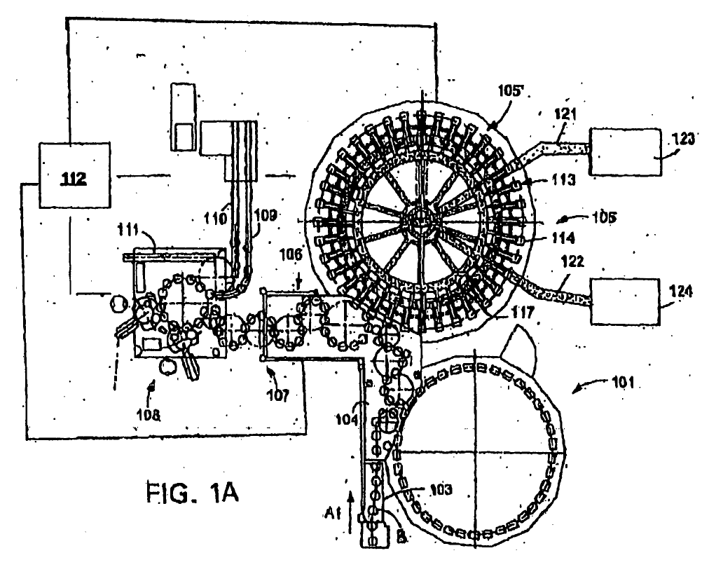

FIG. 1A shows schematically the main components of one embodiment example of a system for filling containers, specifically, an embodiment of a beverage bottling plant 100 for filling bottles B with liquid beverage filling material, in accordance with one embodiment, or in which system or plant could possibly be utilized at least one aspect, or several an aspects, of the embodiments disclosed herein.

FIG. 1A shows a rinsing arrangement or rinsing station 101, to which the containers, namely bottles B, are fed in the direction of travel as is indicated by the arrow A1, by means of a conveyer line or conveyer arrangement to feed bottles to rinsing arrangement 103, and downstream of rinsing arrangement or rinsing station 101, in the direction of travel as is indicated by the arrow A1, the rinsed bottles B are transported to a beverage filling machine 105 by means of a conveyer line or conveyer arrangement 104 to pass bottles to filling machine that is formed, for example, by a starwheel conveyer or a plurality of starwheels of a conveyer arrangement. The conveyer arrangement 104 to pass bottles to filling machine may possibly comprise a starwheel conveying structure that introduces bottles B to the filling machine 105.

Downstream of the filling machine 105, in the direction of travel of the bottles B, there can preferably be a closing arrangement or closing station 106 which closes the bottles B.

The closing arrangement or closing station 106 can, for example, be connected directly to a labeling arrangement or labeling station 108 having at least one labeling unit, device, or module for first product, each unit having a head, such as, for example, by means of a conveyer arrangement 107 to pass bottles to labeling arrangement that may be formed, for example, by a plurality of starwheels of a conveyer arrangement.

In the illustrated embodiment, the labeling arrangement or labeling station 108 having at least one labeling unit, device, or module for first product, each unit having a head has, for example, three outputs, namely one output formed by a conveyer arrangement 109 to convey first product bottles for bottles B that are filled with a first product. The first product may possibly be provided by a first product mixer 123 that is connected to the filling machine 105, for example, through a conduit for first product 121, and bottles B that are filled with a predetermined volume of liquid beverage filling material, that is, the first product, are then labeled by a labeling module in the labeling arrangement or labeling station 108 having at least one labeling unit, device, or module for first product, each unit having a head, corresponding to this first product delivered from first product mixer 123 to the beverage filling machine 105 and thence to the corresponding bottles B.

A second output that is formed by a conveyer arrangement 110 to convey second product bottles is provided for those bottles B that are filled with a second product. The second product may emanate from a second product mixer 124 that is connected, for example, through a conduit for second product 122 to the filling machine 105, and these bottles B filled with a predetermined volume of liquid beverage filling material comprising the second product are then correspondingly labeled by a labeling module in the labeling arrangement or labeling station 108 having at least one labeling unit, device, or module for first product, each unit having a head, corresponding to this second product.

A third output, for example, formed by a conveyer arrangement 111 to convey incorrectly labeled bottles, removes any bottles B which have been incorrectly labeled as may have been determined by an inspecting device or an inspecting station, or an inspecting module 128 that may possibly form a part of the labeling arrangement or labeling station 108 having at least one labeling unit, device, or module for first product, each unit having a head.

In FIG. 1A item 112 is a central control arrangement or, expressed differently, a controller with a computer to process algorithms, which controls the operation of the above-referenced system or plant.

The beverage filling machine 105 is preferably of the revolving design, with a rotor 105′, which revolves around a vertical machine axis. The rotor 105′ is designed to handle the bottles B by the neck. A filling arrangement 114 having at least one filling device, element, apparatus, or valve, comprises an apparatus configured to introduce a predetermined volume of liquid beverage filling material into the interior of bottles B to a predetermined level of liquid beverage filling material. Furthermore, the filling device or apparatus comprises an apparatus configured to terminate the filling of bottles upon liquid beverage filling material reaching the predetermined level in bottles B. In other words, the filling arrangements 114 having at least one filling device, element, apparatus, or valve, are configured and disposed to provide a predetermined flow of liquid beverage filling material from the source thereof, such as, product mixers 123 and 124, into the bottles B.

The toroidal vessel 117 is a component, for example, of the revolving rotor 105′. The toroidal vessel 117 can be connected by means of a rotary coupling or a coupling that permits rotation, and by means of the conduit for first product 121 to the external reservoir or first product mixer 123 to supply the product.

As well as the more typical filling machines having one toroidal vessel, it is possible that in at least one possible embodiment a filling machine could possibly be utilized wherein each filling arrangement 114 having at least one filling device, element, apparatus, or valve is preferably connected by means of two connections to a toroidal vessel 117 which contains a first product, say by means of a first connection, for example, the conduit for first product 121, and to a second toroidal vessel which contains a second product, say by means of the second connection, for example, the conduit for second product 122. In this case, each filling arrangement 114 having at least one filling device, element, apparatus, or valve can also preferably have, at the connections, two individually-controllable fluid or control valves, so that in each bottle B which is delivered at the inlet of the filling machine 105 to a filling position 113, the first product or the second product can be filled by means of an appropriate control of the filling product or fluid valves.

It will be understood that while a two-product assembly or system of a bottling plant is illustrated in FIG. 1A, the disclosure is equally applicable to single-product installations, or other commensurate embodiments.

FIG. 1 shows a simplified illustration of a labeling machine of the prior art, with brushes and brush channels of the prior art.

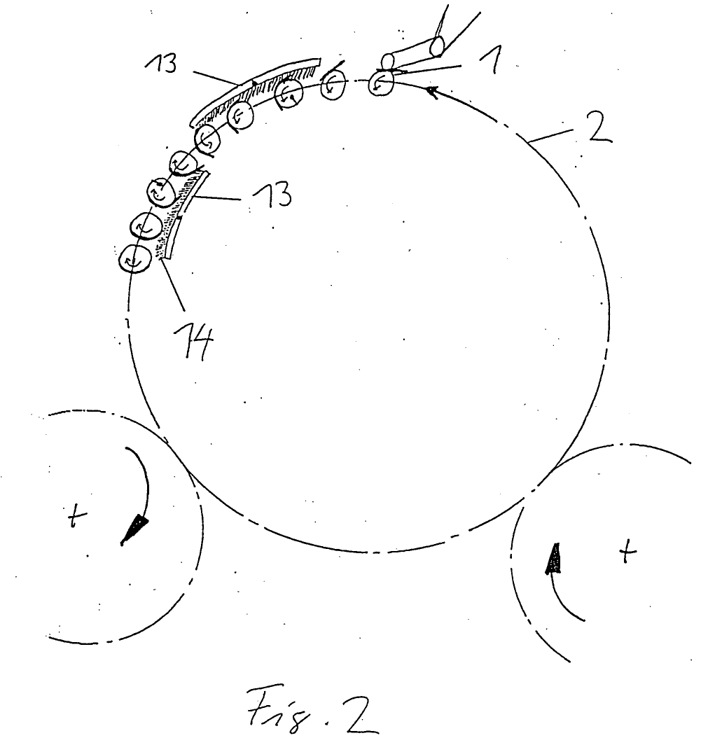

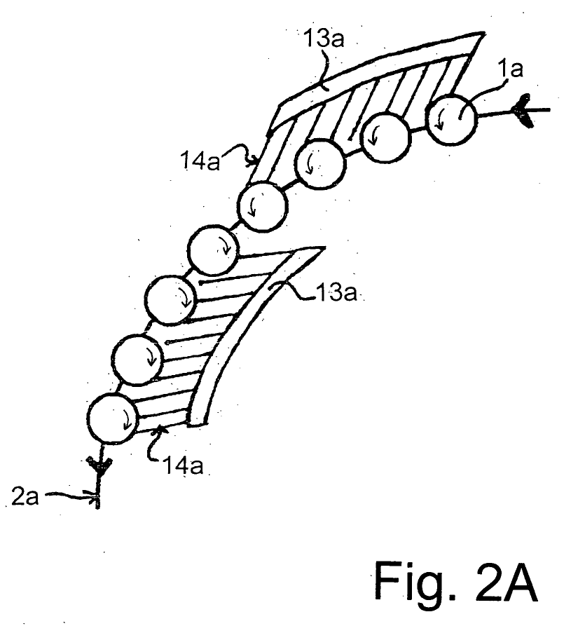

As illustrated in FIG. 2, the containers 1 are located, for example, on a turntable 2 and standing on rotating plates that are driven in rotation and are not shown, are moved past the brushes 13, whereby the brushes 13 can be short individual brushes, larger individual brushes, or even brush mats or brush channels.

It is thereby of particular importance that the bristles 14, which are fixed with one of their ends in a receptacle such as the brush base body for example, are inclined essentially with their entire exposed length in the direction of container transport, so that the free end of the bristle 14 is farther along in the direction of container transport than the fixed end of the bristle 14.

Practical tests have shown that the use of the brushes 13 described above has additional advantages if the length of the bristles 14 is reduced. Currently used brushes conventionally have bristle lengths of approximately 40-50 millimeters. Shortening the bristle length to a range from a few millimeters to a maximum of 30 millimeters produced significant improvements in terms of useful life and the results of the brushing operation. The optimal length of the bristles 14 must be determined for each individual application as a function of the type of label, the container and the processing speed.

Additional advantages can be achieved in particular on labeling machines with turntables that are driven in rotation, whereby the turntables, which are driven by servo motors or stepper motors, in contrast to such turntables that are driven by cams or another type of drive system, offer greater flexibility and thereby facilitate the utilization of the advantages described below.

In certain combinations of container and label, it may be necessary, to achieve a good result of the labeling operation, to first press the label with its center against the container, and then to brush on the unapplied peripheral or side areas of the label. If that is the case, the method illustrated in FIG. 2 is particularly appropriate, in which as a result of a first rotation of the container in a first direction, first a peripheral area of the label is applied, and then, as a result of a second rotation of the container in an opposite, second direction, the other peripheral area of the label is brushed on.

On rotary labeling machines with bottle plates that are driven in rotation or on linear machines in which the containers rotate around their vertical axis, additional wear-reducing effects can be achieved by reducing the depth of immersion of the containers in the bristles 14. This reduction is possible because on account of the self-rotation of the container, the label comes in contact over almost its entire surface with the bristles 14, which makes possible a shallow depth of immersion. By contrast, labeling machines that do not have self-rotation of the container require a deep immersion, because on these machines the bristles 14 must reach the entire surface of the label. Immersion depths of 0 to 20 millimeters, preferably 2-5 millimeters, have been found to be particularly advantageous.

FIG. 2A shows an expanded view of a brush section of a labeling machine according to at least one possible embodiment. Brushes 13a are disposed on either side of a stream of containers 1a, such as beverage bottles, carried on a rotary platform 2a. The brushes 13a have individual bristles or packs of bristles 14a, which are oriented at an angle with respect to the brush 13a. The bristles 14a are also oriented at an angle with respect to the path or direction of travel of the containers 1a. The bristles 14a contact labels attached to the containers 1a and smooth the labels over the surface of the containers 1a. The brushes 13a, in at least one embodiment, are stationary.

As discussed above with respect to FIG. 2, the containers 1a can each be located on a corresponding platform that can be rotated independently of the other bottle platforms. In such an arrangement, the labels are placed on the containers 1a at or offset from the center of the label, such that the two ends of the label project out and away from the container 1a. As the containers 1a approach the first of the brushes 13a, the containers 1a are rotated counterclockwise as seen in FIG. 2a. The containers 1a do not complete a full 360 degree rotation, but rather execute a partial rotation to smooth down and apply one of the free ends of the label to the container 1a. After the containers 1a travel through the first brush 13a, the containers 1a are rotated clockwise, i.e. the opposite direction of rotation. In this manner, the other free end of the label on each container 1a is smoothed down. Again, only a partial rotation of the containers 1a in the clockwise direction is necessary to smooth down and apply the remaining free label end to the container 1a. The individual rotation of the containers 1a is controlled by an appropriate motorized drive system, such as rotatable platforms driven by servomotors or stepper motors. These platforms and motors can be controlled by a computerized control system to execute the appropriate movements at the desired intervals. In at least one embodiment, different speeds of movement and rotation can be employed depending on such factors as the size and shape of the containers to be labeled, the type of labels, the type and/or quality of adhesive or other attaching substance on the labels, etc. Also, the size and number of the brushes could be adjusted to accommodate different containers and types of labels.

In the context of an additional and extremely advantageous configuration, a labeling machine as claimed by the present application is equipped with brushes 13 which, in addition to the features described above, are realized so that during the brushing, they execute a painting movement which runs from the center and/or the middle of a label to its peripheral areas, as a result of which the label is applied almost without creases, which represents an improvement over the prior art.

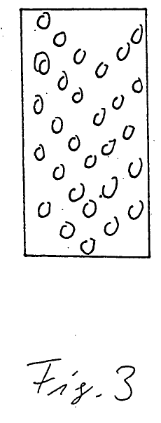

This painting movement directed from inside to outside can be achieved, for example, by arranging the bristle bundles inside the brush base body—for this purpose a plurality of individual bristles are generally combined to simplify the brush manufacturing process—not in straight rows as in the prior art, but in the shape of arrows, as can be seen in FIG. 3. In this case, care must be taken that the tips of said rows of bristle bundles, when installed, are approximately at the height of the middle of the label.

FIG. 3 shows a brush base body with bundles of bristles arranged in the shape of an arrow.

In an additional configuration of an embodiment, the labeling machine taught by the present application is equipped with brush cylinders that are driven in rotation, whereby the peripheral surfaces of said brush cylinders are provided at least partly with bristles 14, the location and/or orientation of which correspond to the description presented above.

The present application also teaches that brush cylinders with an essentially vertical axis of rotation must be driven so that during the brushing process the bristles 14 move opposite to the direction of transport of the containers.

For brush cylinders with an essentially horizontal axis of rotation, the present application teaches that the direction of rotation is selected as a function of the labeling task.

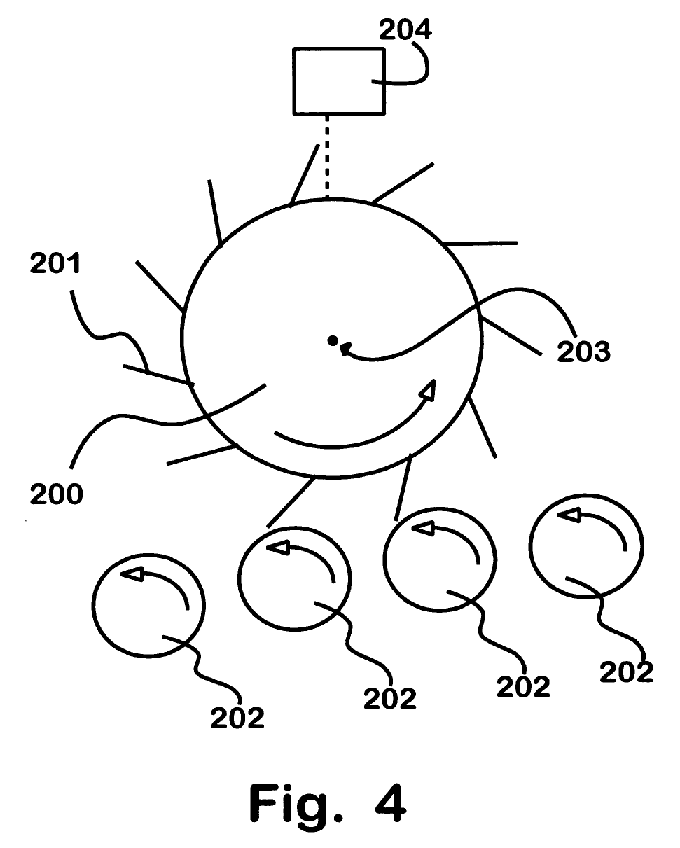

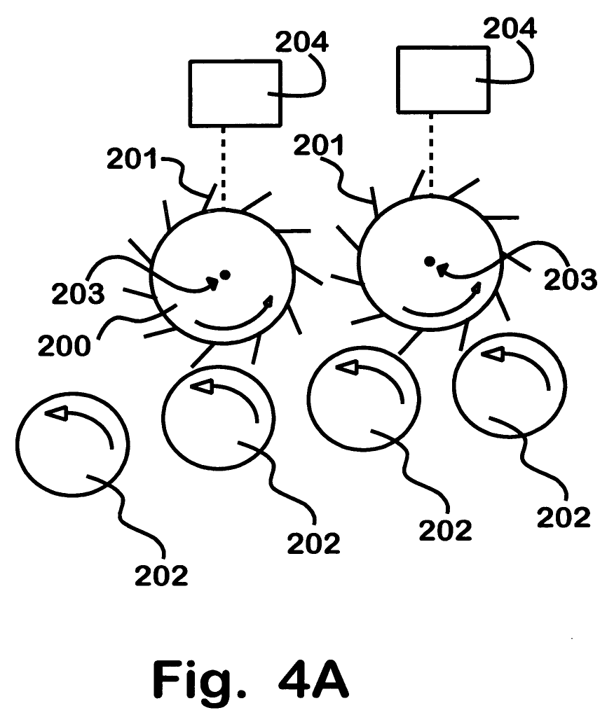

FIG. 4 shows a top view of a rotatable brush cylinder 200 with a vertical axis of rotation 203 for use in a labeling machine according to at least one possible embodiment. The brush cylinder 200 is connected to a control and drive mechanism 204 that rotates the brush cylinder 200 about its central axis of rotation 203. In the embodiment shown, bristles or bristle bundles 201 are located on the perimeter or exterior surface of the brush cylinder 200. The bristles 201 extend at an angle with respect to a radius of the cylinder 200. In the embodiment shown, containers 202, are moved on individual platforms (not shown), that are rotated on a large rotary platform, as seen in other embodiments discussed herein. The containers 202 are rotated counterclockwise as they approach and contact the bristles 201 of the brush cylinder 200. The brush cylinder 200 is also rotating counterclockwise about its vertical axis 203 so that the bristles 201 brush across the containers 202 as the containers 202 rotate. In this manner, the bristles 201 smooth down labels on the exteriors of the containers 202.

It is to be understood that FIG. 4 shows only one example of a brush cylinder 200 and bristle 201 design. The brush cylinder 201 could be elongated in height, such that the cylinder might have a rod or barrel shape, or could be short in height, such that the cylinder would be essentially disk shaped. The bristles 201 could be arranged at different angles. The number of bristles 201 could be increased or decreased as desired. One or more layers of bristles 201 could be disposed about the exterior of the brush cylinder 200. For example, a longer cylinder 200 could have multiple layers of bristles 201 up and down its height, possibly corresponding to the vertical height of the container 202 or label to brush the entire label in one motion. Further, the length of the bristles 201 could be increased ir decreased as desired. In addition, the speed of rotation of the brush cylinder 200 could be adjusted as desired, as well as the speed and direction of rotation of the containers 202.

FIG. 4a shows an alternative embodiment of the arrangement shown in FIG. 4 with more than one brush cylinder 200. The brush cylinders 200, and bristles 201 thereof, in the embodiment shown are smaller in diameter than the brush cylinder 200 shown in FIG. 4. Each of the brush cylinders 200 shown in FIG. 4a is operatively or directly connected to its own corresponding drive and control system 204. However, in an alternative embodiment, multiple brush cylinders 200 could be connected to a single drive and control system 204. The operation of the embodiment shown in FIG. 4a is the same as that of the embodiment shown in FIG. 4, except more than one brush cylinder 200 is used. It should be understood that, in further possible embodiments, multiple brush cylinders 200 of various sizes could be utilized as desired.

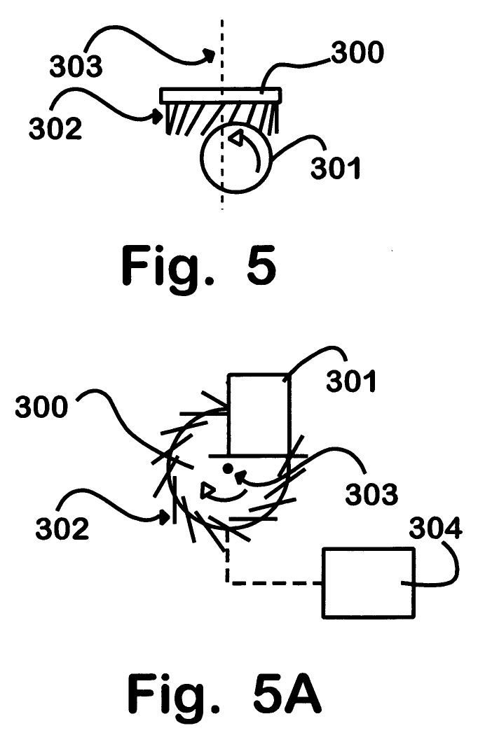

FIG. 5 shows a top view of a rotatable brush cylinder 300 with a horizontal axis of rotation 303 for use in a labeling machine according to at least one possible embodiment. In the embodiment shown in FIG. 5, the bristles 302 extend at an angle with respect to the end face of the brush cylinder 300. The bristles 302 project out of the end face in the manner of a hair brush or tooth brush. As the brush cylinder 300 rotates about its axis, the bristles 302 contact the 301 at an angle in a similar fashion to that of other embodiments disclosed herein. FIG. 5a shows a side view of the arrangement shown in FIG. 5, with a drive and control arrangement 304 connected to the brush cylinder 300. The horizontal axis of rotation 303 is also shown. As can be seen in FIG. 5a, the bristles or bristle bundles 302 are located about the brush cylinder 300 in a circular arrangement adjacent the perimeter edge of the brush cylinder 300. The bristles 302 are angled and positioned to contact the container 301 at an angle to smooth down a label as discussed above with respect to other possible embodiments.

As stated above with respect to FIGS. 4 and 4a, FIGS. 5 and 5a show one possible embodiment, and it therefore should be understood that various modifications thereof are within the scope of the application. For example, the brush cylinder 300 size and rotational speed could be adjusted as desired. Multiple brush cylinders 300 could be used. Additional bristles or bristle bundles 302 could be added to the end face of the brush cylinder 300 to cover a greater portion of the end face of the brush cylinder 300 than is covered in FIG. 5a. Further, bristles 302 could be added such that the entirety of the end face of the brush cylinder 300 would be covered.

In the context of the present application, the terms “brush” 13 and “bristle” 14 are defined broadly to include components that perform the same or equivalent action of brushing or applying the labels to the containers. Such components include, for example, flexible, elastically deformable plastic elements that can be realized in the form of rags, tufts, fingers or similar elements. These components can also be made of foamed or cellular material such as, for example, plastic foam rollers that are driven in rotation.

The examples listed above are cited merely by way of example, and are in no case intended to limit the scope of the present application. The use of other components that are not explicitly cited here is still within the scope of protection of the present application. Further, the figures shown herewith are for purposes of example and should not be considered

One feature or aspect of an embodiment is believed at the time of the filing of this patent application to possibly reside broadly in a labeling machine for the labeling of containers such as bottles, cans and similar items with self-adhesive labels and/or labels that are processed with cold-setting adhesive, realized in the form of a rotary or linear machine with at least one handling position for the transfer of the labels to the containers, with at least one handling position that is provided with at least one brush for the transfer of the labels to the container, characterized by the fact that the bristles of the at least one brush are inclined in the direction of transport of the container.

Another feature or aspect of an embodiment is believed at the time of the filing of this patent application to possibly reside broadly in a labeling machine, characterized by the fact that the angle formed between the container transport direction and the bristles is less than 90 degrees.

Yet another feature or aspect of an embodiment is believed at the time of the filing of this patent application to possibly reside broadly in a labeling machine, characterized by the fact that the angle formed between the container transport direction and the bristles is preferably approximately 30 degrees.

Still another feature or aspect of an embodiment is believed at the time of the filing of this patent application to possibly reside broadly in a labeling machine, characterized by the fact that the length of the bristles of the at least one brush is between 0 and 30 millimeters.

A further feature or aspect of an embodiment is believed at the time of the filing of this patent application to possibly reside broadly in a labeling machine, characterized by the fact that the at least one brush is realized in the form of a brush cylinder that is driven in rotation.

Another feature or aspect of an embodiment is believed at the time of the filing of this patent application to possibly reside broadly in a labeling machine, characterized by the fact that the brush cylinder driven in rotation has a vertical axis of rotation.

Yet another feature or aspect of an embodiment is believed at the time of the filing of this patent application to possibly reside broadly in a labeling machine, characterized by the fact that the brush cylinder driven in rotation has a horizontal axis of rotation.

Still another feature or aspect of an embodiment is believed at the time of the filing of this patent application to possibly reside broadly in a labeling machine, characterized by the fact that the labeling machine is realized so that the direction of rotation of the brush cylinder driven in rotation with a vertical axis of rotation is designed so that during the brushing process, the bristles move opposite to the direction of transport of the containers.

A further feature or aspect of an embodiment is believed at the time of the filing of this patent application to possibly reside broadly in a labeling machine, characterized by the fact that the bristle bundles are arranged in the brush base body in the form of an arrow.

Another feature or aspect of an embodiment is believed at the time of the filing of this patent application to possibly reside broadly in a labeling machine, characterized by the fact that the depth of immersion of the container 1 in the bristles 14 of the at least one brush 13 is less than 30 millimeters, preferably 0 to 5 millimeters.

Yet another feature or aspect of an embodiment is believed at the time of the filing of this patent application to possibly reside broadly in a beverage bottling plant for filling beverage bottles with a liquid beverage filling material, said beverage bottling plant comprising: a beverage bottle cleaning machine being configured and disposed to clean empty beverage bottles; a feed arrangement to supply empty beverage bottles to said beverage bottle cleaning machine; a beverage filling machine being configured and disposed to fill empty beverage bottles with liquid beverage material; said beverage filling machine comprising a plurality of beverage filling devices for filling beverage bottles with liquid beverage material; at least one storage unit being configured and disposed to store a supply of liquid beverage material; at least one supply line being configured and disposed to connect said at least one storage unit to said beverage filling machine to supply liquid beverage material to said beverage filling machine; a first conveyer arrangement being configured and disposed to move empty beverage bottles from said beverage bottle cleaning machine into said beverage filling machine; said first conveyer arrangement comprising a star wheel structure; a beverage bottle closing machine being configured and disposed to close tops of filled beverage bottles; a second conveyer arrangement being configured and disposed to move filled beverage bottles from said beverage filling machine into said beverage bottle closing machine; said second conveyer arrangement comprising a star wheel structure; a beverage bottle labeling station being configured and disposed to label filled, closed beverage bottles; a third conveyor arrangement being configured and disposed to move filled, closed beverage bottles from said beverage bottle closing machine into said beverage bottle labeling station; said third conveyer arrangement comprising a star wheel structure; and said beverage bottle labeling station comprising: a transport device comprising a plurality of beverage bottle handling devices; each of said beverage bottle handling devices comprising a rotatable beverage bottle holding device configured and disposed to rotate a corresponding vertically-disposed beverage bottle about the vertical axis of the beverage bottle; at least one label transfer device being configured and disposed to attach labels onto corresponding beverage bottles; at least one brush structure being configured and disposed to further attach and smooth labels onto corresponding beverage bottles; said at least one brush structure comprising a plurality of bristles; each of said plurality of bristles having a first end and a second end opposite said first end; said first end being connected to its corresponding brush structure; and said second end being disposed after and a distance from said first end along the path of travel of a beverage bottle, wherein each bristle of said plurality of bristles is disposed at an angle with respect to the path of movement of the beverage bottles, and wherein the beverage bottles, during travel, first pass said first end of each bristle and then contact said second end of said bristle.

Still another feature or aspect of an embodiment is believed at the time of the filing of this patent application to possibly reside broadly in a method of operating a beverage bottling plant for filling beverage bottles with a liquid beverage filling material, said beverage bottling plant comprising: a beverage bottle cleaning machine being configured and disposed to clean empty beverage bottles; a feed arrangement to supply empty beverage bottles to said beverage bottle cleaning machine; a beverage filling machine being configured and disposed to fill empty beverage bottles with liquid beverage material; said beverage filling machine comprising a plurality of beverage filling devices for filling beverage bottles with liquid beverage material; at least one storage unit being configured and disposed to store a supply of liquid beverage material; at least one supply line being configured and disposed to connect said at least one storage unit to said beverage filling machine to supply liquid beverage material to said beverage filling machine; a first conveyer arrangement being configured and disposed to move empty beverage bottles from said beverage bottle cleaning machine into said beverage filling machine; said first conveyer arrangement comprising a star wheel structure; a beverage bottle closing machine being configured and disposed to close tops of filled beverage bottles; a second conveyer arrangement being configured and disposed to move filled beverage bottles from said beverage filling machine into said beverage bottle closing machine; said second conveyer arrangement comprising a star wheel structure; a beverage bottle labeling station being configured and disposed to label filled, closed beverage bottles; a third conveyor arrangement being configured and disposed to move filled, closed beverage bottles from said beverage bottle closing machine into said beverage bottle labeling station; said third conveyer arrangement comprising a star wheel structure; and said beverage bottle labeling station comprising: a transport device comprising a plurality of beverage bottle handling devices; each of said beverage bottle handling devices comprising a rotatable beverage bottle holding device configured and disposed to rotate a corresponding vertically-disposed beverage bottle about the vertical axis of the beverage bottle; at least one label transfer device being configured and disposed to attach labels onto corresponding beverage bottles; at least one brush structure being configured and disposed to further attach and smooth labels onto corresponding beverage bottles; said at least one brush structure comprising a plurality of bristles; each of said plurality of bristles having a first end and a second end opposite said first end; said first end being connected to its corresponding brush structure; and said second end being disposed after and a distance from said first end along the path of travel of a beverage bottle, wherein each bristle of said plurality of bristles is disposed at an angle with respect to the path of movement of the beverage bottles, and wherein the beverage bottles, during travel, first pass said first end of each bristle and then contact said second end of said bristle, said method comprising the steps of: supplying empty beverage bottles to said beverage bottle cleaning machine; cleaning the empty beverage bottles; transporting empty beverage bottles to said beverage filling machine; filling empty beverage bottles with liquid beverage material; transporting filled beverage bottles to said beverage bottle closing machine; closing tops of filled beverage bottles; transporting filled beverage bottles to said beverage bottle labeling station; placing filled beverage bottles vertically on corresponding a rotatable beverage bottle holding device; attaching labels onto filled beverage bottles at or offset from the middle of said labels; moving partially-labeled beverage bottles into a first brush structure, such that the beverage bottles first pass said first end of said bristles before contacting said second end of said bristles; rotating beverage bottles in a first direction against said angled bristles of said first brush structure to further attach and smooth one unattached end of said labels; moving partially-labeled beverage bottles into a second brush structure disposed on a side of the path of travel of the beverage bottles opposite the side on which said first brush structure is located, such that the beverage bottles first pass said first end of said bristles before contacting said second end of said bristles; and rotating beverage bottles in a second direction opposite said first direction against said angled bristles of said second brush structure to further attach and smooth the other unattached end of said labels.

A further feature or aspect of an embodiment is believed at the time of the filing of this patent application to possibly reside broadly in a beverage bottling plant for filling bottles with a liquid beverage filling material, having a labeling machine for the labeling of containers such as bottles, cans and similar items with self-adhesive labels and/or labels that are processed with cold-setting adhesive, realized in the form of a rotary or linear machine, with at least one handling position for the transfer of the labels to the containers, with at least one handling position that is provided with at least one brush for the transfer of the labels to the container, whereby the bristles of the at least one brush are inclined in the direction of transport of the container.

The components disclosed in the various publications, disclosed or incorporated by reference herein, may possibly be used in possible embodiments of the present invention, as well as equivalents thereof.

Some examples of bottling systems that may possibly be utilized or possibly adapted for use in at least one possible embodiment of the present application may possibly be found in the following U.S. patents, all assigned to the Assignee herein, namely: U.S. Pat. No. 4,911,285; U.S. Pat. No. 4,944,830; U.S. Pat. No. 4,950,350; U.S. Pat. No. 4,976,803; U.S. Pat. No. 4,981,547; U.S. Pat. No. 5,004,518; U.S. Pat. No. 5,017,261; U.S. Pat. No. 5,062,917; U.S. Pat. No. 5,062,918; U.S. Pat. No. 5,075,123; U.S. Pat. No. 5,078,826; U.S. Pat. No. 5,087,317; U.S. Pat. No. 5,110,402; U.S. Pat. No. 5,129,984; U.S. Pat. No. 5,167,755; U.S. Pat. No. 5,174,851; U.S. Pat. No. 5,185,053; U.S. Pat. No. 5,217,538; U.S. Pat. No. 5,227,005; No. U.S. Pat. 5,413,153; U.S. Pat. No. 5,558,138; U.S. Pat. No. 5,634,500; U.S. Pat. No. 5,713,403; U.S. Pat. No. 6,276,113; U.S. Pat. No. 6,213,169; U.S. Pat. No. 6,189,578; U.S. Pat. No. 6,192,946; U.S. Pat. No. 6,374,575; U.S. Pat. No. 6,365,054; U.S. Pat. No. 6,619,016; U.S. Pat. No. 6,474,368; U.S. Pat. No. 6,494,238; U.S. Pat. No. 6,470,922; and U.S. Pat. No. 6,463,964.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

Some examples of stepping motors that may possibly be utilized or possibly adapted for use in at least one possible embodiment of the present application may possibly be found in the following U.S. Pat. No. 6,348,774 issued to Andersen et al. on Feb. 19, 2002; U.S. Pat. No. 6,373,209 issued to Gerber et al. on Apr. 16, 2002; U.S. Pat. No. 6,424,061 issued to Fukuda et al. on Jul. 23, 2002; U.S. Pat. No. 6,509,663 issued to Aoun on Jan. 21, 2003; U.S. Pat. No. 6,548,923 to Ohnishi et al. on Apr. 15, 2003; and U.S. Pat. No. 6,661,193 issued to Tsai on Dec. 9, 2003.

The appended drawings in their entirety, including all dimensions, proportions and/or shapes in at least one embodiment of the invention, are accurate and are hereby included by reference into this specification.

Some examples of sensors that may possibly be utilized or possibly adapted for use in at least one possible embodiment of the present application may possibly be found in the following U.S. Pat. No. 6,062,248 issued to Boelkins on May 16, 2000; U.S. Pat. No. 6,223,593 issued to Kubisiak et al. on May 1, 2001; U.S. Pat. No. 6,466,035 issued to Nyfors et al. on Oct. 15, 2002; U.S. Pat. No. 6,584,851 issued to Yamagishi et al. on Jul. 1, 2003; U.S. Pat. No. 6,631,638 issued to James et al. on Oct. 14, 2003; and U.S. Pat. No. 6,707,307 issued to McFarlane et al. on Mat. 16, 2004.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Some examples of servo-motors that may possibly be utilized or possibly adapted for use in at least one possible embodiment of the present application may possibly be found in the following U.S. Pat. No. 4,050,434 issued to Zbikowski et al. on Sep. 27, 1977; U.S. Pat. No. 4,365,538 issued to Andoh on Dec. 28, 1982; U.S. Pat. No. 4,550,626 issued to Brouter on Nov. 5, 1985; U.S. Pat. No. 4,760,699 issued to Jacobsen et al. on Aug. 2, 1988; U.S. Pat. No. 5,076,568 issued to de Jong et al. on Dec. 31, 1991; and No. 6,025 issued to Yasui on Feb. 15, 2000.

All, or substantially all, of the components and methods of the various embodiments may be used with at least one embodiment or all of the embodiments, if more than one embodiment is described herein.

Some examples of bottling systems which may possibly be utilized or adapted for use in at least one possible embodiment may possibly be found in the following U.S. Pat. No. 6,684,602, entitled “Compact bottling machine;” U.S. Pat. No. 6,470,922, entitled “Bottling plant for bottling carbonated beverages;” U.S. Pat. No. 6,390,150, entitled “Drive for bottling machine;” U.S. Pat. No. 6,374,575, entitled “Bottling plant and method of operating a bottling plant;” U.S. Pat. No. 6,192,946, entitled “Bottling system;” U.S. Pat. No. 6,185,910, entitled “Method and an apparatus for high-purity bottling of beverages;” U.S. Pat. No. 6,058,985, entitled “Bottling machine with a set-up table and a set-up table for a bottling machine and a set-up table for a bottle handling machine;” U.S. Pat. No. 5,996,322, entitled “In-line bottling plant;” U.S. Pat. No. 5,896,899, entitled “Method and an apparatus for sterile bottling of beverages;” U.S. Pat. No. 5,848,515, entitled “Continuous-cycle sterile bottling plant;” U.S. Pat. No. 5,634,500, entitled “Method for bottling a liquid in bottles or similar containers;” and U.S. Pat. No. 5,425,402, entitled “Bottling system with mass filling and capping arrays.”

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

Some examples of labeling machines which may possibly be utilized in at least one possible embodiment may possibly be found in the following U.S. Pat. No. 6,634,400, entitled “Labeling machine;” U.S. Pat. No. 6,561,246, entitled “Labeling machine capable of precise attachment of a label to different sizes of containers;” U.S. Pat. No. 6,550,512, entitled “Labeling machine capable of preventing erroneous attachment of labels on containers;” U.S. Pat. No. 6,543,514, entitled “In-line continuous feed sleeve labeling machine and method;” U.S. Pat. No. 6,378,587, entitled “Cylindrical container labeling machine;” U.S. Pat. No. 6,328,086, entitled “Labeling machine;” U.S. Pat. No. 6,315,021, entitled “Labeling machine;” U.S. Pat. No. 6,263,940, entitled “In-line continuous feed sleeve labeling machine and method;” U.S. Pat. No. 6,199,614, entitled “High speed labeling machine having a constant tension driving system;” U.S. Pat. No. 6,167,935, entitled “Labeling machine; U.S. Pat. No. 6,066,223, entitled “Labeling machine and method; U.S. Pat. No. 6,050,319, entitled “Non-round container labeling machine and method;” and U.S. Pat. No. 6,045,616, entitled “Adhesive station and labeling machine.”

All of the patents, patent applications and publications recited herein, and in the Declaration attached hereto, are hereby incorporated by reference as if set forth in their entirety herein.

Some examples of starwheels which may possibly be utilized or adapted for use in at least one possible embodiment may possibly be found in the following U.S. Pat. No. 5,613,593, entitled “Container handling starwheel;” U.S. Pat. No. 5,029,695, entitled “Improved starwheel;” U.S. Pat. No. 4,124,112, entitled “Odd-shaped container indexing starwheel;” and U.S. Pat. No. 4,084,686, entitled “Starwheel control in a system for conveying containers.”

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

Some examples of beverage bottling systems which may possibly be utilized or adapted for use in at least one possible embodiment may possibly be found in the following U.S. Patents, and are hereby incorporated by reference as if set forth in their entirety herein: U.S. Pat. No. 6,494,238, entitled “Plant for filling beverage into beverage bottles and other beverage containers having apparatus for replacing remaining air volume in filled beverage bottles or other beverage containers;” U.S. Pat. No. 6,474,368, entitled “Beverage container filling machine, and method for filling containers with a liquid filling material in a beverage container filling machine;” No. U.S. Pat. 6,470,922, entitled “Bottling plant for bottling carbonated beverages;” U.S. Pat. No. 6,463,964, entitled “Method of operating a machine for filling bottles, cans or the like beverage containers with a beverage, and a beverage container filling machine;” U.S. Pat. No. 6,374,575, entitled “Bottling plant and method of operating a bottling plant;” U.S. Pat. No. 6,365,054, entitled “Plant for filling containers and a method for operating a plant for filling containers,” U.S. Pat. No. 6,192,946, entitled “Bottling system;” U.S. Pat. No. 6,189,578, entitled “Filling system and filling element;” U.S. Pat. No. 6,058,985, entitled “Bottling machine with a set-up table and a set-up table for a bottling machine and a set-up table for a bottle handling machine;” U.S. Pat. No. 5,713,403, entitled “Method and system for filling containers with a liquid filling product, and filling machine and labelling device for use with this method or system,” U.S. Pat. No. 5,634,500, entitled “Method for bottling a liquid in bottles or similar containers;” and U.S. Pat. No. 5,413,153, entitled “Container filling machine for filling open-top containers, and a filler valve therefor.”

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

The corresponding foreign and international patent publication applications, namely, Federal Republic of Germany Patent Application No. 103 57 329.1, filed on Dec. 5, 2003, having inventor Martin SCHACH, and DE-OS 103 57 329.1 and DE-PS 103 57 329.1, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The following patent publications are hereby incorporated by reference as if set forth in their entirety herein: DE 25 22 261 A1; DE-AS 11 22 434; DE 197 22 067 A1; DE 30 38 308 A1; DE-PS 4 603; DE 297 22 675 U1; DE 296 10 209 U1; and U.S. Pat. No. 4,473,429

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):

A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

1. A beverage bottling plant for filling beverage bottles with a liquid beverage filling material, said beverage bottling plant comprising:
a beverage bottle cleaning machine being configured and disposed to clean empty beverage bottles;
a feed arrangement to supply empty beverage bottles to said beverage bottle cleaning machine;
a beverage filling machine being configured and disposed to fill empty beverage bottles with liquid beverage material;
said beverage filling machine comprising a plurality of beverage filling devices for filling beverage bottles with liquid beverage material;
at least one storage unit being configured and disposed to store a supply of liquid beverage material;
at least one supply line being configured and disposed to connect said at least one storage unit to said beverage filling machine to supply liquid beverage material to said beverage filling machine;
a first conveyer arrangement being configured and disposed to move empty beverage bottles from said beverage bottle cleaning machine into said beverage filling machine;
said first conveyer arrangement comprising a star wheel structure;
a beverage bottle closing machine being configured and disposed to close tops of filled beverage bottles;
a second conveyer arrangement being configured and disposed to move filled beverage bottles from said beverage filling machine into said beverage bottle closing machine;
said second conveyer arrangement comprising a star wheel structure;
a beverage bottle labeling station being configured and disposed to label filled, closed beverage bottles;
a third conveyor arrangement being configured and disposed to move filled, closed beverage bottles from said beverage bottle closing machine into said beverage bottle labeling station;
said third conveyer arrangement comprising a star wheel structure; and said beverage bottle labeling station comprising:
a transport device comprising a plurality of beverage bottle handling devices;
each of said beverage bottle handling devices comprising a rotatable beverage bottle holding device configured and disposed to rotate a corresponding vertically-disposed beverage bottle about the vertical axis of the beverage bottle;
at least one label transfer device being configured and disposed to attach labels onto corresponding beverage bottles;
at least one brush structure being configured and disposed to further attach and smooth labels onto corresponding beverage bottles;
said at least one brush structure comprising a plurality of bristles;
each of said plurality of bristles having a first end and a second end opposite said first end;
said first end being connected to its corresponding brush structure; and
said second end being disposed after and a distance from said first end along the path of travel of a beverage bottle, wherein each bristle of said plurality of bristles is disposed at an angle with respect to the path of movement of the beverage bottles, and wherein the beverage bottles, during travel, first pass said first end of each bristle and then contact said second end of said bristle.

2. The beverage bottling plant according to claim 1, characterized by the fact that the angle formed between the beverage bottle transport direction and the bristles is less than 90 degrees.

3. The beverage bottling plant according to claim 2, characterized by the fact that the angle formed between the beverage bottle transport direction and the bristles is preferably approximately 30 degrees.

4. The beverage bottling plant according to claim 3, characterized by the fact that the length of the bristles of the at least one brush is between 0 and 30 millimeters.

5. The beverage bottling plant according to claim 4, characterized by the fact that the at least one brush is realized in the form of a brush cylinder that is driven in rotation.

6. The beverage bottling plant according to claim 5, characterized by the fact that the brush cylinder driven in rotation has one of: a vertical axis of rotation and a horizontal axis of rotation.

7. The beverage bottling plant according to claim 6, characterized by the fact that the labeling machine is realized so that the direction of rotation of the brush cylinder driven in rotation with a vertical axis of rotation is designed so that during the brushing process, the bristles move opposite to the direction of transport of the beverage bottles.

8. The beverage bottling plant according to claim 7, characterized by the fact that the bristle bundles are arranged in the brush base body in the form of an arrow.

9. The beverage bottling plant according to claim 8, characterized by the fact that the depth of immersion of the beverage bottle in the bristles of the at least one brush is less than 30 millimeters, preferably 0 to 5 millimeters.

10. The labeling machine according to claim 1 for the labeling of containers such as bottles, cans and similar items with self-adhesive labels and/or labels that are processed with cold-setting adhesive, realized in the form of a rotary or linear machine with at least one handling position for the transfer of the labels to the containers, with at least one handling position that is provided with at least one brush for the transfer of the labels to the container, characterized by the fact that the bristles of the at least one brush are inclined in the direction of transport of the container.

11. Labeling machine as claimed in claim 10, characterized by the fact that the angle formed between the container transport direction and the bristles is less than 90 degrees.

12. Labeling machine as claimed in claim 11, characterized by the fact that the angle formed between the container transport direction and the bristles is preferably approximately 30 degrees.

13. Labeling machine as claimed in claim 12, characterized by the fact that the length of the bristles of the at least one brush is between 0 and 30 millimeters.

14. Labeling machine as claimed in claim 13, characterized by the fact that the at least one brush is realized in the form of a brush cylinder that is driven in rotation.

15. Labeling machine as claimed in claim 14, characterized by the fact that the brush cylinder driven in rotation has one of: a vertical axis of rotation and a horizontal axis of rotation.

16. Labeling machine as claimed in claim 15, characterized by the fact that the labeling machine is realized so that the direction of rotation of the brush cylinder driven in rotation with a vertical axis of rotation is designed so that during the brushing process, the bristles move opposite to the direction of transport of the containers.

17. Labeling machine as claimed in claim 13, characterized by the fact that the bristle bundles are arranged in the brush base body in the form of an arrow.

18. Labeling machine as claimed in claim 17, characterized by the fact that the depth of immersion of the container 1 in the bristles 14 of the at least one brush 13 is less than 30 millimeters, preferably 0 to 5 millimeters.

19. Labeling machine as claimed in claim 16, characterized by the fact that the bristle bundles are arranged in the brush base body in the form of an arrow; and the depth of immersion of the container 1 in the bristles 14 of the at least one brush 13 is less than 30 millimeters, preferably 0 to 5 millimeters.

20. A method of operating a beverage bottling plant for filling beverage bottles with a liquid beverage filling material, said beverage bottling plant comprising: a beverage bottle cleaning machine being configured and disposed to clean empty beverage bottles; a feed arrangement to supply empty beverage bottles to said beverage bottle cleaning machine; a beverage filling machine being configured and disposed to fill empty beverage bottles with liquid beverage material; said beverage filling machine comprising a plurality of beverage filling devices for filling beverage bottles with liquid beverage material; at least one storage unit being configured and disposed to store a supply of liquid beverage material; at least one supply line being configured and disposed to connect said at least one storage unit to said beverage filling machine to supply liquid beverage material to said beverage filling machine; a first conveyer arrangement being configured and disposed to move empty beverage bottles from said beverage bottle cleaning machine into said beverage filling machine; said first conveyer arrangement comprising a star wheel structure; a beverage bottle closing machine being configured and disposed to close tops of filled beverage bottles; a second conveyer arrangement being configured and disposed to move filled beverage bottles from said beverage filling machine into said beverage bottle closing machine; said second conveyer arrangement comprising a star wheel structure; a beverage bottle labeling station being configured and disposed to label filled, closed beverage bottles; a third conveyor arrangement being configured and disposed to move filled, closed beverage bottles from said beverage bottle closing machine into said beverage bottle labeling station; said third conveyer arrangement comprising a star wheel structure; and said beverage bottle labeling station comprising: a transport device comprising a plurality of beverage bottle handling devices; each of said beverage bottle handling devices comprising a rotatable beverage bottle holding device configured and disposed to rotate a corresponding vertically-disposed beverage bottle about the vertical axis of the beverage bottle; at least one label transfer device being configured and disposed to attach labels onto corresponding beverage bottles; at least one brush structure being configured and disposed to further attach and smooth labels onto corresponding beverage bottles; said at least one brush structure comprising a plurality of bristles; each of said plurality of bristles having a first end and a second end opposite said first end; said first end being connected to its corresponding brush structure; and said second end being disposed after and a distance from said first end along the path of travel of a beverage bottle, wherein each bristle of said plurality of bristles is disposed at an angle with respect to the path of movement of the beverage bottles, and wherein the beverage bottles, during travel, first pass said first end of each bristle and then contact said second end of said bristle, said method comprising the steps of:
supplying empty beverage bottles to said beverage bottle cleaning machine;
cleaning the empty beverage bottles;
transporting empty beverage bottles to said beverage filling machine;
filling empty beverage bottles with liquid beverage material;
transporting filled beverage bottles to said beverage bottle closing machine;
closing tops of filled beverage bottles;
transporting filled beverage bottles to said beverage bottle labeling station;
placing filled beverage bottles vertically on corresponding a rotatable beverage bottle holding device;
attaching labels onto filled beverage bottles at or offset from the middle of said labels;
moving partially-labeled beverage bottles into a first brush structure, such that the beverage bottles first pass said first end of said bristles before contacting said second end of said bristles;
rotating beverage bottles in a first direction against said angled bristles of said first brush structure to further attach and smooth one unattached end of said labels;
moving partially-labeled beverage bottles into a second brush structure disposed on a side of the path of travel of the beverage bottles opposite the side on which said first brush structure is located, such that the beverage bottles first pass said first end of said bristles before contacting said second end of said bristles; and
rotating beverage bottles in a second direction opposite said first direction against said angled bristles of said second brush structure to further attach and smooth the other unattached end of said labels.
